(19) United States
(12) Patent Application Publication
(10) Pub. No.: US 2018/0250684 A1
(43) Pub. Date: Sep. 6, 2018

(54) SPLIT FRAME

(71) Applicant: Metso Minerals, Inc., Helsinki (FI)

(72) Inventors: Vesa-Matti Salminen, Akaa (FI); Tuomas Juutinen, Tampere (FI)

(73) Assignee: Metso Minerals, Inc., Helsinki (FI)

(21) Appl. No.: 15/756,762

(22) PCT Filed: Aug. 26, 2016
(86) PCT No.: PCT/FI2016/050586

§ 371 Date: Mar. 1, 2018

(30) Foreign Application Priority Data
Sep. 9, 2015 (FI) 20155649

(51) Int. Cl. B02C 21/02; B07B 1/00

(52) U.S. Cl. CPC B02C 21/02; B07B 1/005

(57) ABSTRACT

A mineral material processing plant including a base frame, an intermediate frame configured to be attached on top of the base frame of a mineral material processing plant and at least one actuator, wherein the intermediate frame is configured to support the at least one actuator.

### FIELD OF INVENTION

The invention generally relates to a mineral material processing plant. In particular, but not exclusively, the invention relates to a mobile mineral material processing plant. In particular, but not exclusively, the invention relates to a frame structure of a mobile mineral material processing plant.

### BACKGROUND OF THE INVENTION

Mineral material, such as stone, is retrieved to be processed from the ground either by exploding or by digging. The mineral material may also comprise natural stone, gravel and construction waste. Both mobile and fixed plants are used for processing. The material to be processed is fed with e.g. an excavator or a wheel loader into a feed hopper of the processing plant, from where the material is forwarded to be processed.

A mobile mineral material processing plant is driven for short distances with its own transport means, such as tracks, wheels or skids. However, for transport over long distances, the mobile plant needs to be disassembled in order to reach a reasonable transport height. The disassembly comprises detaching the actuators, e.g. feed hopper and crusher from the plant and transporting the separately from the frame, or trackbed, of the plant. Furthermore, in a fixed plant, disassembly is required e.g. for service purposes.

Disassembly of such a mineral material processing plant is time consuming and requires large effort. The objective of the invention is to provide a mineral material processing plant with improved flexibility of operation and transport.

### SUMMARY

According to a first aspect of the invention there is provided a mineral material processing plant, comprising
a base frame;
an intermediate frame configured to be attached on top of the base frame of a mineral material processing plant; and
at least one actuator; wherein
the intermediate frame is configured to support the at least one actuator.

The intermediate frame may further comprise hydraulic legs configured to raise the intermediate frame from and lower the intermediate frame onto the top of the base frame.

The intermediate frame may further comprise elements extending longitudinally on the side of the intermediate frame for aligning the intermediate frame with the base frame.

The elements for aligning the intermediate frame with the base frame may comprise a bottom surface extending below the hydraulic legs when retracted.

The hydraulic legs may be comprised in hydraulic leg elements configured to be pivoted against the intermediate frame—

The at least one actuator may comprise a crusher, a screen and/or a feed hopper.

The mineral material processing plant may further comprise a conveyor the height and/or angle of which is changeable with adjusting means.

The mineral material processing plant may be a mobile plant.

According to a second aspect of the invention there is provided a method of disassembling a mineral material processing plant, comprising
raising an intermediate frame from a base frame using hydraulic legs comprised in hydraulic leg elements; and
transporting the base frame away from under the intermediate frame.

The method may further comprise lowering the intermediate frame using hydraulic legs so that the intermediate frame is supported on a surface by bottom surfaces of elements.

The method may further comprise pivoting the hydraulic leg elements against the intermediate frame.

According to a third aspect of the invention there is provided an intermediate frame for supporting at least one actuator on a frame of a mineral material processing plant, comprising
hydraulic leg elements comprising extendable and retractable hydraulic legs;
elements extending longitudinally on the side of the intermediate frame, the elements comprising a bottom surface extending below the hydraulic legs when retracted, wherein
the hydraulic leg elements are configured to be pivoted against the intermediate frame.

Different embodiments of the present invention will be illustrated or have been illustrated only in connection with some aspects of the invention. A skilled person appreciates that any embodiment of an aspect of the invention may apply to the same aspect of the invention and other aspects

### BRIEF DESCRIPTION OF THE DRAWINGS

The invention will now be described, by way of example, with reference to the accompanying drawings, in which:

FIG. 1 shows a schematic view of an intermediate frame according to an example embodiment of the invention;

FIG. 2 shows a schematic view of a split frame mineral material processing plant according to an example embodiment of the invention with the intermediate frame according to an embodiment of the invention not attached;

FIG. 3 shows a schematic view of a split frame mineral material processing plant according to an example embodiment of the invention with the intermediate frame according to an embodiment of the invention attached; and

FIG. 4 shows a flow chart of a method of disassembling a mineral material processing plant according to an example embodiment of the invention.

### DETAILED DESCRIPTION

In the following description, like numbers denote like elements. It should be appreciated that the illustrated figures are not entirely in scale, and that the figures mainly serve the purpose of illustrating embodiments of the invention.

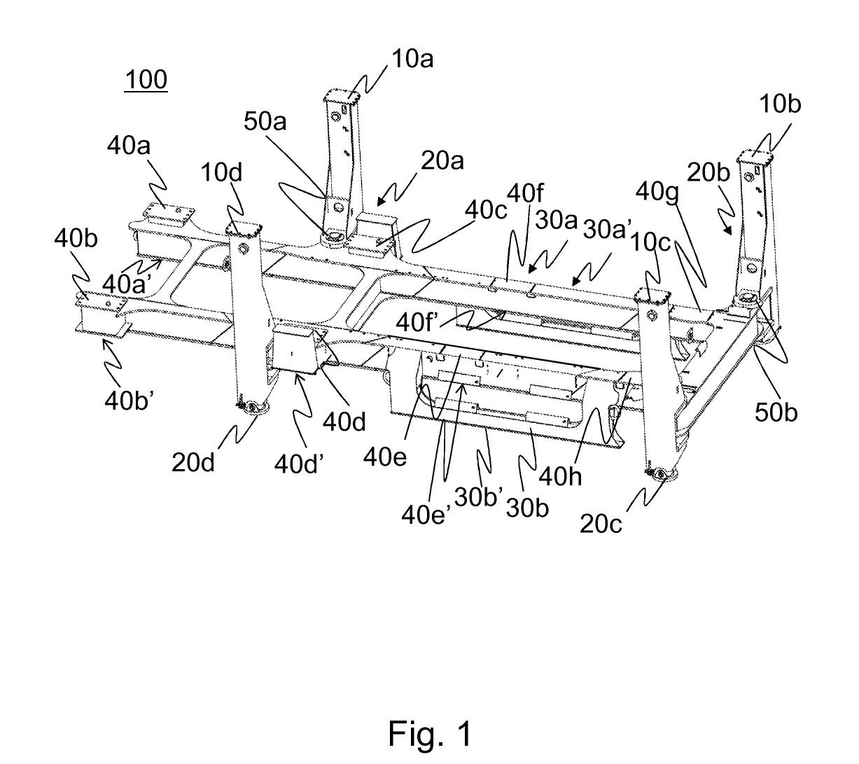

FIG. 1 shows a schematic view of an intermediate frame 100 according to an example embodiment of the invention. The intermediate frame comprises a frame structure according to the given situation. A skilled person understands that the exact measures and the structure of the beams and support beams of the intermediate frame 100 are chosen in accordance with the situation and in accordance with the mineral material processing plant in which the intermediate frame is to be used.

The intermediate frame 100 comprises hydraulic leg elements 10a-d from which hydraulic legs 20a-d are extendable and in which retractable. The intermediate frame 100 further comprises elements 30a-b for configured to align the intermediate frame 100 with the base on which it is lowered and attached. The elements 30a,30b comprise lower surfaces 30a′,30b′ situated below the frame structure of the intermediate frame 100, i.e. forming the lowest surface of the frame when the hydraulic legs 20a-c do not support the intermediate frame, i.e. the surfaces 30a′,30b′ lie below the retracted hydraulic legs 20a-d. Accordingly, the support surfaces 30a′,30b′ are configured to support the intermediate frame 100 on a surface, for example on a bed of a truck during transport or on the ground.

The hydraulic leg elements 10a-d comprise pivot points 50a-d (only 50a-b shown) around which the hydraulic leg elements are configured to be pivoted against the intermediate frame 100 for transport and/or storage and/or service.

In an embodiment, the hydraulic leg elements 10a-d are pivoted 90 degrees. In a pivoted position of the hydraulic leg elements, the support surfaces 30a′,30b′ support the intermediate frame e.g. during transport.

The intermediate frame 100 further comprises attaching means (not shown) with the use of which the intermediate frame 100 is attached, with conventional means such as bolts or clamps, to the base on which it is lowered. In a further example embodiment, the intermediate frame 100 is held in place sideways with the alignment means 30a-b and longitudinally e.g. using a form fitting protrusion (not shown).

The intermediate frame 100 is configured to support at least one actuator, e.g. a screen, feed hopper or a crusher thereon. The at least one actuator is attached to the intermediate frame 100 in a conventional manner, e.g. on attachment points 40a-40d having lower surfaces 40a′-40d′. A further actuator is in an embodiment attached to further attachment points 40e-40h having lower surfaces 40e′-40h′.

In an embodiment, an actuator is installed so that a part of it lies below the main horizontal portion of the intermediate frame. For example in case of a jaw crusher, the jaw crusher is attached to the intermediate frame 100 in such a way that a part of the jaw crusher lies below the main horizontal part of the intermediate frame 100 in order to have the attachment point closer to the centre of gravity of the crusher for better control of dynamic forces. Accordingly, the surfaces 30a′,30b′ are also situated in such away below the main horizontal portion of the intermediate frame in order to support the intermediate frame 100 on a surface when the hydraulic legs 20a-d are retracted, so that the actuator does not touch the surface

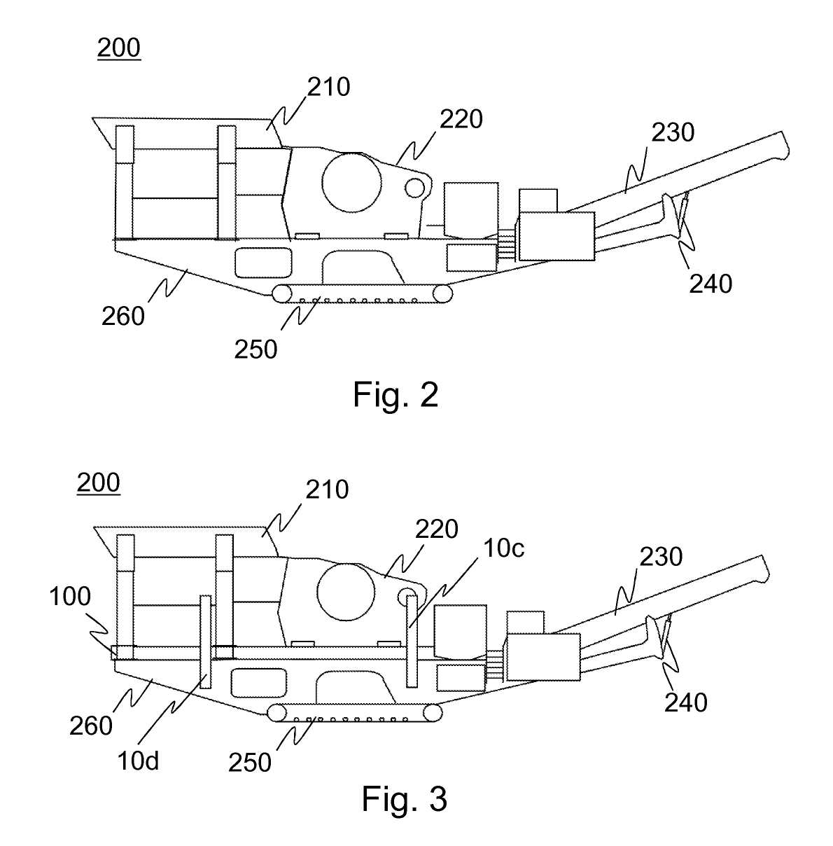

FIGS. 2 and 3 show a schematic view of a split frame mineral material processing plant 200 according to an example with the intermediate frame 100 according to an embodiment of the invention not attached and attached. A skilled person appreciates that the mineral material processing plant in an embodiment comprises parts and element not shown, such as motors, conveyors and control elements.

The mineral material processing plant 200 comprises at least one actuator, such as a feed hopper 210 and a crusher 220. In an embodiment, the number of actuators is two, e.g. a feed hopper 210 and a crusher 220. In a further embodiment the number of actuators is one or more than two, e.g. a feed hopper, a screen and a crusher.

The mineral material processing plant 200 further comprises a conveyor 230 for conveying the processed material from the actuators. The height and/or angle of the conveyor is configured to be adjusted with adjusting means 240. In an embodiment the adjusting means comprise hydraulic means, such as hydraulic jacks. In an example embodiment the mineral material processing plant 200 further comprises a base frame 260 comprising tracks 250 for driving the mineral material processing plant 200. In a further example embodiment, the base frame comprises wheels, legs or skids instead of tracks. In a further example embodiment, the mineral material processing plant is a fixed plant and the track base rests in a fixed location.

The intermediate frame is installed between the base frame 260 and the at least one actuator 210,220, allowing the at least one actuator to be raised away from the base frame 260 and lowered on the base frame using the hydraulic leg elements 10a-d,20a-d. The intermediate frame 100 is configured to support the at least one actuator 210,220. By raising the intermediate frame, the mineral material processing plant is easily disassembled e.g. for transport or service. Furthermore, actuators 210,220 can be removed at the same time and transported as a single unit using the intermediate frame 100.

In an example embodiment, the intermediate frame is aligned on the base frame using the elements 30a-b (FIG. 1) and supported on the base frame on the lower surface 40a′-40d′ of the attachment points 40a-d (FIG. 1) and in an embodiment also on the lower surface 40e′-40h′ of the attachment points 40e-h (FIG. 1).

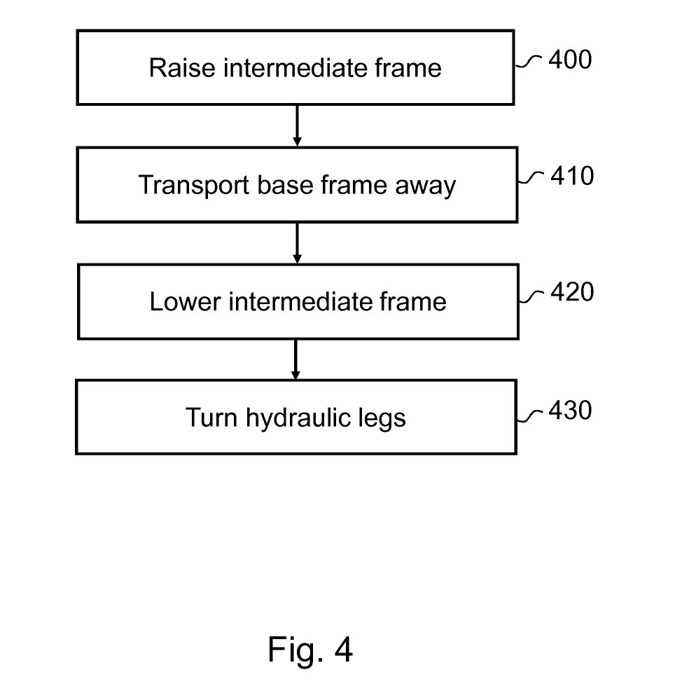

FIG. 4 chart of a method of disassembling a mineral material processing plant according to an example embodiment of the invention. At 400, the intermediate frame 100 is raised away from the base frame 260, after being detached from the base frame 260, i.e. the after e.g. the bolts or clamps have been released. At 410, the base frame 260 is transported away from under the base frame. In case of a mobile plant the base frame 260 is driven and in case of a fixed plant transported in another manner. At 420 the intermediate frame is lowered, i.e. the hydraulic legs 20a-d are retracted and the intermediate frame is lowered on a surface, such as ground or bed of a truck, and supported thereon by the surfaces 30a′,30b′. At 430 the hydraulic leg elements are pivoted, or turned, against the frame e.g. for transport, storage or service.

Assembling the mineral material processing plant is achieved by carrying out the same steps in opposite order.

Without in any way limiting the scope of protection, interpretation or possible applications of the invention, a technical advantage of different embodiments of the invention may be considered to be transport of the mineral material processing plant in fewer pieces. Further, a technical advantage of different embodiments of the invention may be considered to be easier and faster manufacturing of the plant, as the actuators can be manufactured on the intermediate frame. Still further, a technical advantage of different embodiments of the invention may be considered to be increased height of the plant with increased space under the actuators. Still further, a technical advantage of different embodiments of the invention may be considered to be easier service operations.

The foregoing description provides non-limiting examples of some embodiments of the invention. It is clear to a person skilled in the art that the invention is not restricted to details presented, but that the invention can be implemented in other equivalent means. Some of the features of the above-disclosed embodiments may be used to advantage without the use of other features.

As such, the foregoing description shall be considered as merely illustrative of the principles of the invention, and not in limitation thereof. Hence, the scope of the invention is only restricted by the appended patent claims.

1. A mineral material processing plant, comprising:
a base frame;
an intermediate frame configured to be attached on top of the base frame of a mineral material processing plant and supported on the base frame on the lower surface of attachment points; and
at least one actuator; wherein
the intermediate frame is configured to support the at least one actuator on the attachment points, and the base frame is configured to support the intermediate frame and at least one actuator; and that the intermediate frame further comprises elements extending longitudinally on the side of the intermediate frame for aligning the intermediate frame with the base frame; wherein the elements comprise a bottom surface extending below the frame structure of the intermediate frame.

2. The mineral material processing plant of claim 1, wherein the intermediate frame further comprises hydraulic legs configured to raise the intermediate frame from and lower the intermediate frame onto the top of the base frame.

3. The mineral material processing plant of claim 1, wherein the intermediate frame further comprises elements extending longitudinally on the side of the intermediate frame for aligning the intermediate frame with the base frame.

4. The mineral material processing plant of claim 3, wherein the elements for aligning the intermediate frame with the base frame comprise a bottom surface extending below the hydraulic legs when retracted.

5. The mineral material processing plant of any claim 2, wherein the hydraulic legs are comprised in hydraulic leg elements configured to be pivoted against the intermediate frame.

6. The mineral material processing plant of claim 1, wherein the at least one actuator comprises a crusher, a screen and/or a feed hopper.

7. The mineral material processing plant of claim 1, further comprising a conveyor the height and/or angle of which is changeable with adjusting means.

8. The mineral material processing plant of claim 1, wherein the mineral material processing plant is a mobile plant.

9. A method of disassembling a mineral material processing plant, comprising:
raising an intermediate frame supported on a base frame on the lower surface of attachment points from the base frame using hydraulic legs comprised in hydraulic leg elements;
transporting the base frame away from under the intermediate frame, wherein the intermediate frame is configured to support at least one actuator on the attachment points, and the base frame is configured to support at least one actuator; and lowering the intermediate frame using hydraulic legs so that the intermediate frame is supported on a surface by bottom surfaces extending below the frame structure of the intermediate frame of elements extending longitudinally on the side of the intermediate frame for aligning the intermediate frame with the base frame.

10. (canceled)

11. The method of claim 9, further comprising pivoting the hydraulic leg elements against the intermediate frame.

12. (canceled)
